(19) United States
(12) Patent Application Publication
(10) Pub. No.: US 2026/0196237 A1
(43) Pub. Date: Jul. 9, 2026

(54) EFFICIENT TIME DELAY SYNTHESIS

(71) Applicant: Telefonaktiebolaget LM Ericsson (publ), Stockholm (SE)

(72) Inventor: Erik NORVELL, UPPLANDS VÄSBY (SE)

(21) Appl. No.: 19/128,423

(22) PCT Filed: Nov. 8, 2023
(86) PCT No.: PCT/EP2023/081137

§ 371 Date: May 8, 2025

Related U.S. Application Data
(60) Provisional application No. 63/423,983, filed on Nov. 9, 2022.

(51) Int. Cl. G10L 21/04; H04S 7/00

(52) U.S. Cl. CPC G10L 21/04; H04S 7/30

(57) ABSTRACT

There is provided techniques for adjusting timing of output audio signals to achieve desired inter-channel time difference (ITD) between output audio signals. A method comprises receiving a current ITD value and an audio frame, and determining transition times t1, t2 to perform a time shift to apply to at least one of a first output signal and a second output signal based on the ITD of a current frame and an ITD of a previous frame. The time shift within the determined transition times t1, t2 is applied in generation of the first output signal and the second output signal.

### TECHNICAL FIELD

The present disclosure relates generally to communications, and more particularly to communication methods and related devices and nodes supporting audio encoding and decoding.

### BACKGROUND

Spatial audio is a description of a sound field that immerses a listener. There are several formats of spatial audio. The most common one is the stereo format, where the sound field is rendered through either two speakers or a set of headphones. In scenarios where the playback is on a larger set of loudspeakers, such as 5.1, 7.1+4 or 22.2, spatial audio is often referred to as multichannel audio. There are also spatial audio formats that do not depend on the layout of the loudspeaker system, but rather describes the sound field itself. Such descriptions include the Wave Field Synthesis (WFS), where the sound field is captured by an array of microphones and symmetrically reproduced by an array of loudspeakers. Another popular format is the Ambisonics, which rely on spherical harmonics captured with a compact microphone array. Ambisonics has become more popular recently, since they are suitable for listener centric rendering such as Virtual Reality (VR) and Augmented Reality (AR) audio rendering, and they are inherently suitable for rotation. They may also be coupled with a 360-video capture for reconstruction of an experienced scene.

The multichannel audio formats may be played back directly on the loudspeaker setup that they are designed for. However, if there is not a loudspeaker configuration, the audio cannot be played back without adapting the audio. This adaptation is often referred to as rendering the spatial audio for the playback system. If one has a 22.2 multichannel signal or an Ambisonics signal, it may for instance be rendered for playback on a 5.1 system or a set of headphones. When rendering for headphones, the audio that reaches the ears is typically modeled using Head Related Filters (HRF) or Head Related Transfer Functions (HRTF). The filters model the direction of arrival (DoA) of a sound source, such that the listener perceives the sound coming from this direction. This is achieved by a coloration of the spectrum, level difference between the ears and a time difference caused by the difference in length of the path to the left and right ears. This time difference is often referred to as an inter-aural time difference, or an inter-channel time difference (ITD). A time difference between the channels may be created by filtering one or both channels with a Dirac pulse:

$$h = δ ( t - {t}_{Δ} ) .$$

However, the transition between different time shifts, for instance for a moving source, needs to be handled.

### SUMMARY

When modeling the HRF, the spectral coloration may be done using a filter, and the time difference may be generated by time shifts. The present disclosure applies the time shifts in an efficient way when crossing the zero boundary for the shift.

When changing sign of the time delay parameter, one needs to perform a shift operation on both output channels. To limit the complexity of the shift operation, the total transition length is shared between the channels. The sharing is done proportionally to the size of the shift on each side of the zero point.

According to a first aspect there is presented a method for adjusting timing of output audio signals to achieve desired inter-channel time difference (ITD) between output audio signals. The method comprises receiving a current ITD value and an audio frame, and determining transition times t₁, t₂ to perform a time shift to apply to at least one of a first output signal and a second output signal based on the ITD of a current frame and an ITD of a previous frame. The time shift within the determined transition times t₁, t₂ is applied in generation of the first output signal and the second output signal. The method further comprises storing at least part of the audio frame to be used in synthesizing ITD in the following frame.

According to a second aspect there is presented an apparatus for adjusting timing of output audio signals to achieve desired inter-channel time difference, ITD, between output audio signals. The apparatus is adapted to receive a current ITD value and an audio frame, and to determine transition times t₁, t₂ to perform a time shift to apply to at least one of a first output signal and a second output signal based on the ITD of a current frame and an ITD of a previous frame. The apparatus is adapted to apply the time shift within the determined transition times t₁, t₂ in generation of the first output signal and the second output signal.

According to a third aspect there is presented an apparatus comprising processing circuitry and memory coupled with the processing circuitry, wherein the memory includes instructions that when executed by the processing circuitry causes the apparatus to perform operations comprising: receiving a current inter-channel time difference, ITD, value and an audio frame, determining transition times t₁, t₂ to perform a time shift to apply to at least one of a first output signal and a second output signal based on the ITD of a current frame and an ITD of a previous frame, and applying the time shift within the determined transition times t₁, t₂ in generation of the first output signal and the second output signal.

According to a fourth aspect there is presented a computer program comprising program code to be executed by processing circuitry of an apparatus whereby execution of the program code causes apparatus to perform operations of the first aspect.

According to a fifth aspect there is presented a computer program product comprising a non-transitory storage medium including program code to be executed by processing circuitry of an apparatus whereby execution of the program code causes the apparatus to perform operations of the first aspect.

Certain embodiments may provide one or more of the following technical advantage(s). The speed of the adjustment is kept consistent for switches across the zero boundary, and the computational complexity is kept low. The method aims to produce two channels with a time delay, where the time delay may be updated each frame. The updates to the time delay can be done with a minimum of transition artefacts.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating an environment in which various embodiments of the present disclosure may be implemented;

FIG. 2 is a block diagram of an audio object renderer according to some embodiments of the present disclosure;

FIG. 3 is a block diagram of a parametric stereo decoder according to some embodiments of the present disclosure

FIG. 4 is a flow chart illustrating operations of an ITD synthesizer according to some embodiments of the present disclosure;

FIG. 5 is a block diagram of an ITD synthesizer according to some embodiments of the present disclosure;

FIG. 6 is a flow chart illustrating operations of the ITD synthesizer according to some embodiments of the present disclosure;

FIG. 7 is an illustration of buffer operations the ITD synthesizer performs according to some embodiments of the present disclosure;

FIG. 8 is a flow chart illustrating operations of an ITD synthesizer according to some embodiments of the present disclosure;

FIGS. 9-11 are illustrations of buffer operations the ITD synthesizer performs according to some embodiments of the present disclosure;

FIG. 12 is an illustration of a sinc resampling function to handle compressing and extending segments of the signal;

FIG. 13 is a block diagram of an audio object renderer in accordance with some embodiments;

FIG. 14 is a block diagram of a host computer communicating with an encoder and/or a decoder in accordance with some embodiments; and

FIG. 15 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

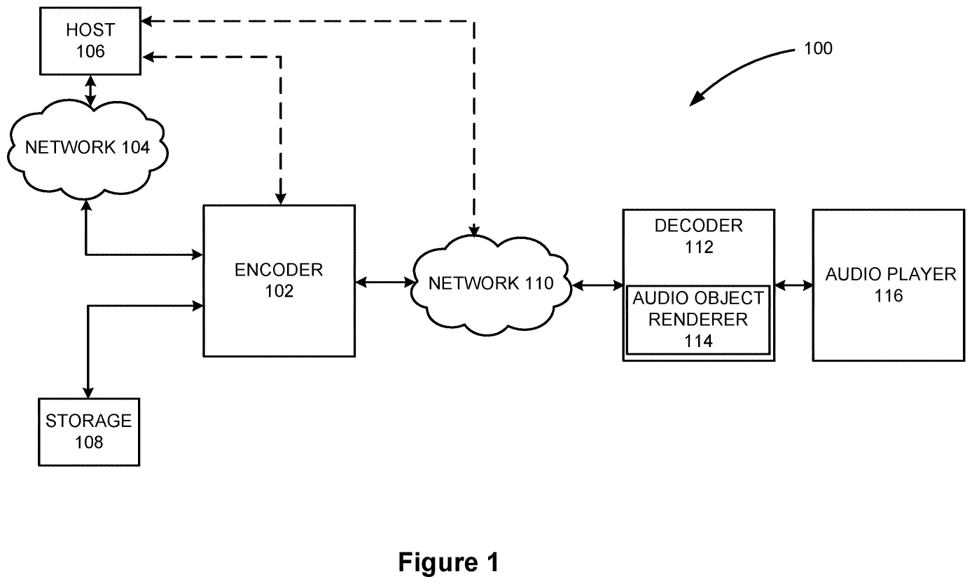

FIG. 1 illustrates an example of an operating environment in which the various embodiments of the present disclosure may be implemented. Turning to FIG. 1, in the example operating environment 100, the encoder 102 receives data, such as an audio file, to be encoded from an entity through network 104, such as a host 106, and/or from storage 108. In some embodiments, the host 106 may communicate directly to the encoder 102. The encoder 102 encodes the audio file as described herein and either stores the encoded audio file in storage 108 or transmits the encoded audio file to a decoder 112 having an audio object renderer 114 via network 110. The audio object renderer 114 within the decoder 112 renders the decoded audio file and transmits the rendered decoded audio file to an audio player 116 for playback. For example, the audio player 116 may play the rendered decoded audio file for a spatial audio representation such as a Virtual Reality conference or computer game. The audio player 116 may be or be comprised in a user equipment, a terminal, a mobile phone, and the like. In other embodiments, the host 106 may transmit encoded audio files to the audio object renderer 114 via network 110. In some embodiments, the audio object renderer 114 may be a stand-alone device between the decoder 112 and audio player 116 in scenarios where the decoded audio does not directly “fit” the audio player 116 as, for example, to render the decoded audio file for headphones.

As previously indicated, when changing sign of the time delay parameter, one needs to perform a shift operation on both output channels. To limit the complexity of the shift operation, the total transition length is shared between the channels. The sharing is done proportionally to the size of the shift on each side of the zero point following the formula:

$$\{ \begin{matrix}{t}_{1} = \frac{{t}_{tot} \vert I T D ( m - 1 ) \vert}{\vert I T D ( m ) \vert + \vert I T D ( m - 1 ) \vert} \\ {t}_{2} = \frac{{t}_{tot} \vert I T D ( m ) \vert}{\vert I T D ( m ) \vert + \vert I T D ( m - 1 ) \vert}\end{matrix}$$

where ITD(m) and ITD(m−1) are inter-channel time differences, m is a subframe index, tₜₒₜ is a total transition length and t₁ and t₂ are the transition lengths to perform time stretching or compressing operations. The time stretching or compressing operation may also be referred to as a time shifting operation or a resampling operation. The transition lengths may be expressed in seconds, or in a number of samples for a discretely sampled audio signal. The transition length may also be referred to as a transition time.

The above formula may be simplified (with integer rounding) to:

$$\{ \begin{matrix}{t}_{1} = [ \frac{{t}_{tot} \vert I T D ( m - 1 ) \vert}{\vert I T D ( m ) \vert + \vert I T D ( m - 1 ) \vert} ] \\ {t}_{2} = {t}_{tot} - {t}_{1}\end{matrix}$$

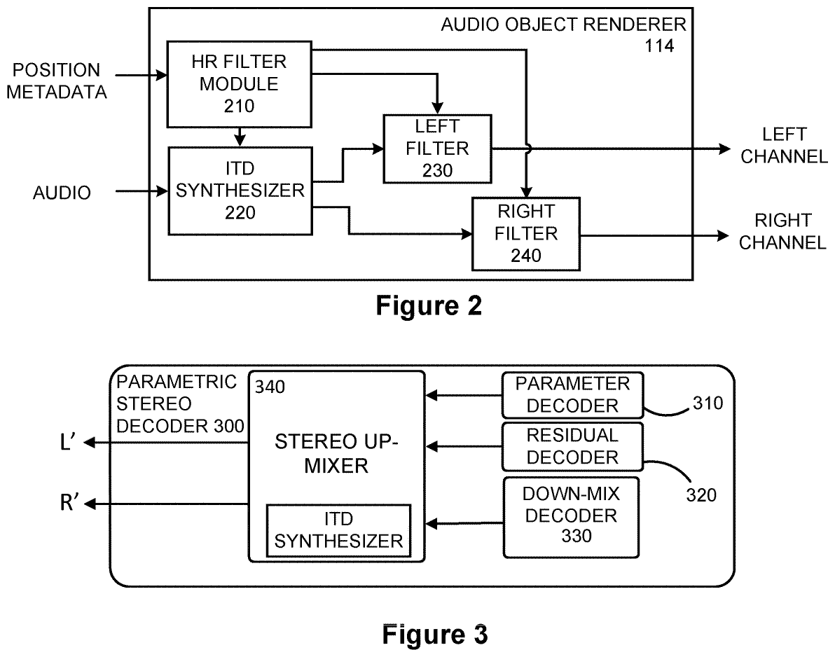

In some embodiments of the present disclosure, the method operates in an ITD synthesizer that is implemented within an audio object renderer 114, as illustrated in FIG. 2. In other embodiments, the ITD synthesizer may be implemented within a parametric stereo decoder. The method operates on segments of audio called frames, where each frame or subframe m consists of N samples.

$$x ( m , n ) , n = 0 , 1 , 2 , ... , N - 1$$

The frames may for instance constitute segments of audio from a decoded audio object, a mono downmix channel in a parametric stereo decoder or an input channel to an audio object renderer. Here, the audio object renderer 114 receives the audio object comprising an audio signal and position metadata, describing the position of the audio object. The position may be absolute or relative to a listener position. The position metadata is input to the HR filter module 210, which provides an ITD value and a set of HR filters for the left and right channels. The time delay parameter for frame m is an integer in the range ITD(m)=[−ITD_{MAX}, ITD_{MAX}].

In case the frames come from a parametric stereo decoder, the ITD(m) can be found by analyzing the input channels to a stereo encoder. Preferably, the input channels are aligned by compensating for the ITD(m) before producing a down-mix channel. The down-mix channel would be encoded together with the stereo parameters including ITD(m), to be decoded and reconstructed in a parametric stereo decoder. The parametric stereo decoder would reconstruct the down-mix signal, the stereo parameters including at least a reconstruction of ITD(m) and synthesize two output channels with the corresponding ITD(m).

The audio and position metadata may e.g., come from an audio object decoder or generated by a 3D audio engine for spatial audio representation such as for a Virtual Reality conference or computer game. The HR filter module 210 may e.g., be a database of stored filters and ITD values, or it may be a model based database producing filters and ITD values for the given position data. The ITD value is input to the ITD synthesizer 220, which produces two output signals based on the input audio frame, where the output signals have the desired ITD. The two channels are filtered through the left and right filters 230 and 240, to produce the synthesized left and right channels. The audio object may be added together with one or more additional objects. The output left and right channels may be forwarded to an audio device for playback.

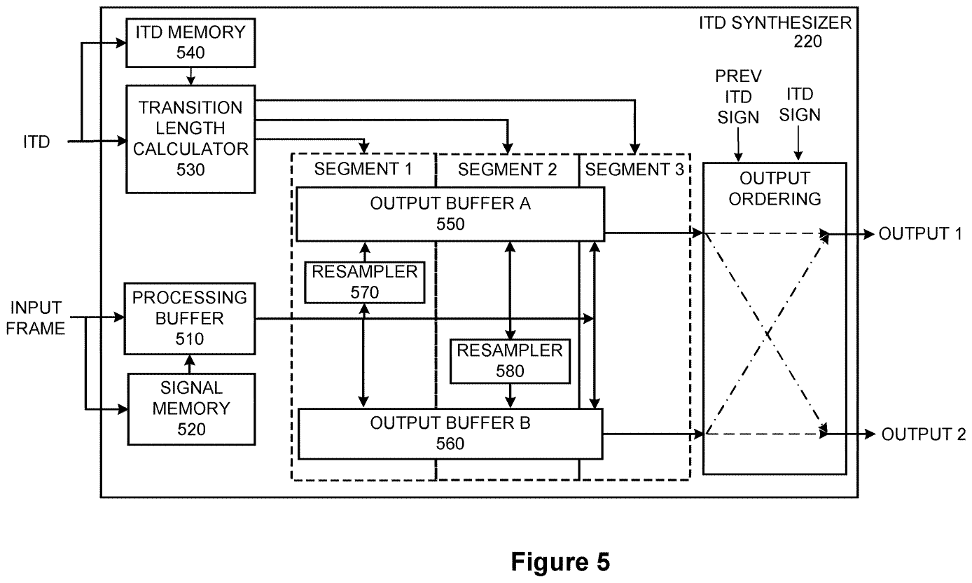

This is illustrated in the flowchart of FIG. 4 of operations of method 400 the ITD synthesizer 220 performs in some embodiments. In block 401, the ITD synthesizer 220 receives a current ITD and an audio frame, wherein each frame m comprises N samples. Upon reception of the audio frame or at any time during the processing of the frame, the ITD synthesizer 220 may store, in block 403, at least a part of the current input audio frame to be used for processing ITD in a following audio frame.

In block 405, the ITD synthesizer 220 determines transition times t₁, t₂ to perform a time shift to apply to at least one of an output signal 0 and an output signal 1 based on signs of an inter-channel time difference, ITD, of the current audio frame and an ITD of a previous audio frame. The ITD comes from the HRF filter module 210 in the context of FIG. 2. In other embodiments where the ITD synthesizer is implemented as part of a parametric stereo decoder, the ITD is reconstructed from a bitstream. Here, the time shift denotes the operation to smoothly transition to a target ITD.

In block 407, the ITD synthesizer 220 applies the time shift within the determined transition times t₁, t₂ in generation of the output signal 0 and the output signal 1.

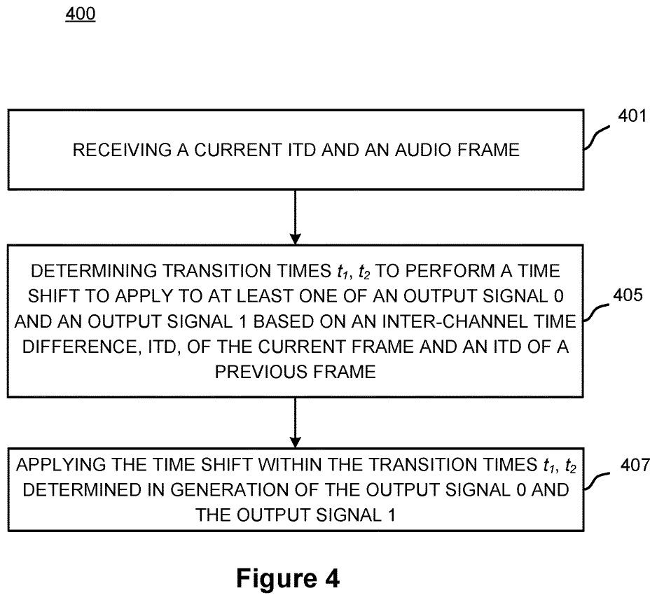

Prior to describing further detail of the ITD synthesizer 220, FIG. 3 illustrates an embodiment where the ITD synthesizer may be implemented within a parametric stereo decoder 300. In the parametric stereo decoder 300, stereo parameters including ITD parameters are decoded by parameter decoder 310, and optionally a reconstructed residual signal is produced by a residual decoder 320. The down-mix decoder 330 is configured to decode and reconstruct an encoded down-mix signal to output reconstructed down-mix signals where the time shift can be applied. The reconstructed down-mix, the reconstructed stereo parameters and optionally a reconstructed residual signal is fed to a stereo up-mixer 340 to produce the reconstructed stereo signal. The ITD synthesizer 220 is part of the stereo up-mixer 340.

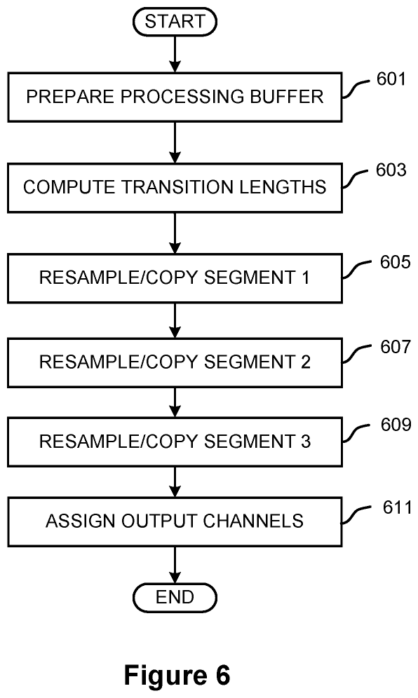

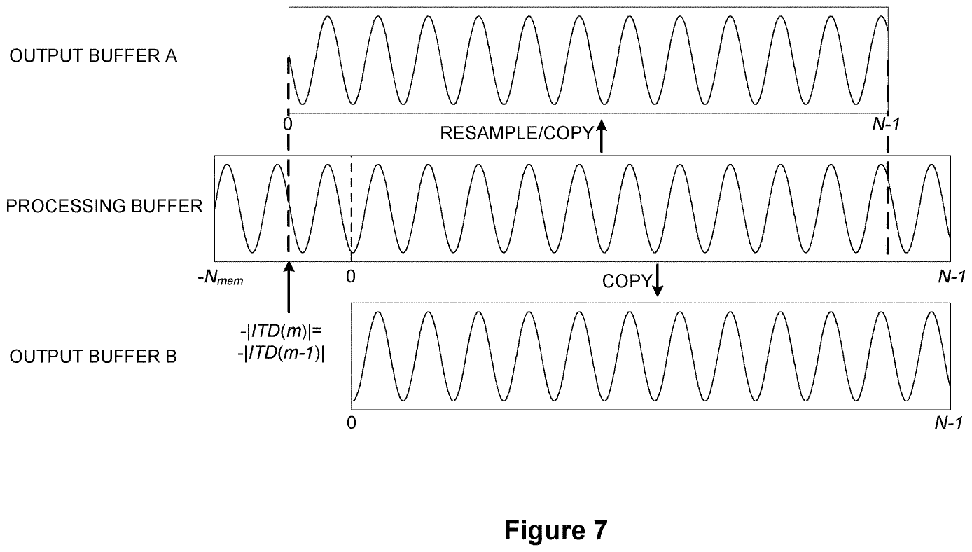

The ITD synthesizer 220 is described in further detail in FIG. 5, and also performs the operations illustrated in FIG. 6. Turning to FIG. 6, in step 601, the processing buffer 510 is populated using the current input audio frame x(m, n) and the signal memory 520. The length of the memory Nₘₑₘ should at least be the sum of the maximum time shift ITD_{MAX} and the lookback/lookahead memory rs_{LA} needed for the resampling function.

$${N}_{mem} = I T {D}_{MAX} + {rs}_{LA}$$

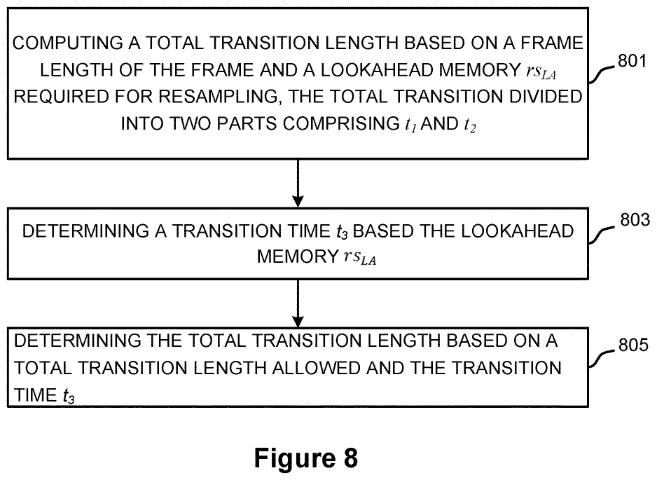

The processing buffer 510 is illustrated in FIG. 7, where the middle plot shows the processing buffer x_{buf}(n), where x_{buf}(0) corresponds to the first value of the current frame. The input frame is also fed to the signal memory 520 to be used in the next frame. In step 603, the ITD value of the current frame ITD(m) is input to the transition length calculator 530, together with ITD(m−1) from the ITD memory 540. The transition lengths are computed based on ITD(m) and ITD(m−1). First the total transition length is computed based on the frame length N and the lookahead rs_{LA} needed by the resampler 570, 580. If ITD(m)<rs_{LA}, a small part of the processing buffer must be kept to accommodate the lookahead without introducing processing delay due to the resampling. The transition may be divided into three parts, t₁, t₂ and t₃. The transition length t₃ may be seen as a buffer length to avoid reading out of memory in the resampling operation. The resampler must leave at least rs_{LA} samples at the end of the buffer to perform the resampling or filtering operation. Transition length t₃ is computed according to

$${t}_{3} = max ( 0 , {rs}_{LA} - \vert I T D ( m ) \vert )$$

The total transition time tₜₒₜ is then

$${t}_{tot} = {N}_{max} - {t}_{3}$$

Where Nₘₐₓ is the maximum allowed transition length. It may be set to Nₘₐₓ=N, meaning that the full frame time is permitted for performing the transition. However, if N is large it may be desirable to limit the maximum allowed transition length using Nₘₐₓ≤N to achieve a faster transition and possibly lower complexity.

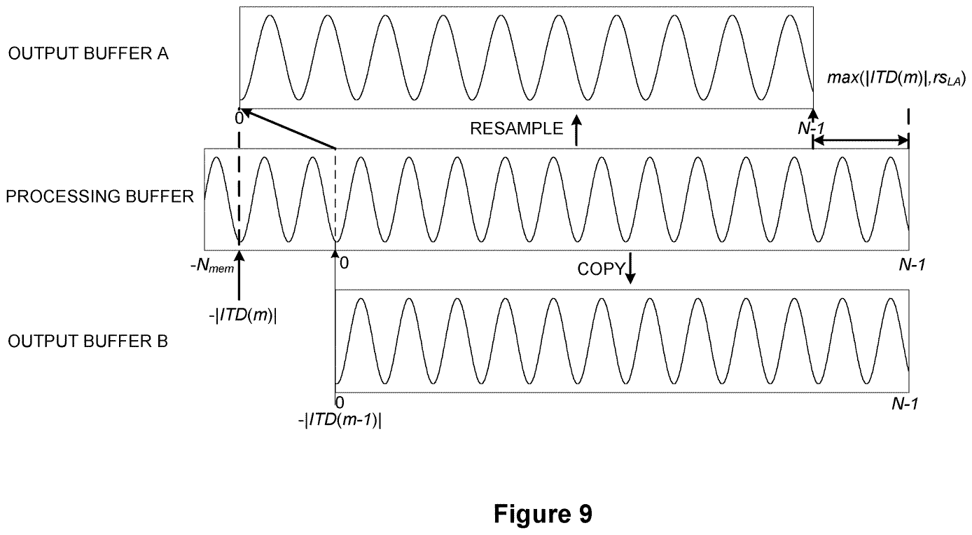

FIG. 8 illustrates operations the ITD synthesizer 220 performs in determining the total transition length. In block 801, the ITD synthesizer 220 computes a total transition length based on a frame length N of the frame m and a lookahead memory rs_{LA} required for resampling, the total transition divided into two parts comprising t₁ and t₂.

In block 803, the ITD synthesizer 220 determines a transition time t₃ based on the lookahead memory rs_{LA}. In block 805, the ITD synthesizer 220 determines a total transition length based on a maximum allowed transition length Nₘₐₓ and the transition time t₃.

The following time shift operations can be divided into two groups:
1. The sign of ITD(m) and ITD(m−1) is the same, or one of them is zero.
2. The sign of the ITD is non-zero and changing, i.e., ITD(m)·ITD(m−1)<0.
   Case 1—Sign of ITD is the Same or One of them is Zero

If the sign of ITD(m) and ITD(m−1) is the same, or if one of them is zero, the shift may be handled by processing just one of the channels, meaning processing step 605 where the resampler 570 adjusts the processing buffer 510 to populate the output buffer A 550. This can be realized by assigning the full transition length to t₁ and setting t₂ to zero, i.e.,

$$\{ \begin{matrix}{t}_{1} = {t}_{tot} \\ {t}_{2} = {t}_{tot} - {t}_{1} = 0 \\ {n}_{1} = - \vert I T D ( m - 1 ) \vert \\ {L}_{in , 1} = {t}_{1} + \vert I T D ( m - 1 ) \vert - \vert I T D ( m ) \vert \\ {n}_{2} = {t}_{1} - \vert I T D ( m ) \vert \\ {L}_{in , 2} = 0 \\ {n}_{3} = {t}_{tot}\end{matrix}$$

where n₁, n₂, n₃ denote the starting indices of each time shift segment assuming that the current input subframe starts at n=0, L_{in,1}, L_{in,2} is the length of the resampling segments 1 and 2. In this case the input signal part of the processing buffer is simply copied to output buffer B 560.

When the time delay of the current frame is the same as the previous frame, i.e., ITD(m)=ITD(m−1), the output time delay synthesis is produced by pointing to the corresponding starting point in the processing buffer. The sign of ITD(m) determines which of the two channels in which to apply the delay. For instance, a positive ITD(m) could indicate that the left channel of a stereo pair is ahead of the right channel, in which case the right channel should be delayed, and the left channel be output without delay. This situation is illustrated in FIG. 7. In this case, the resampling operation on output buffer A 550 has the same input and output length and is equivalent to a copy operation.

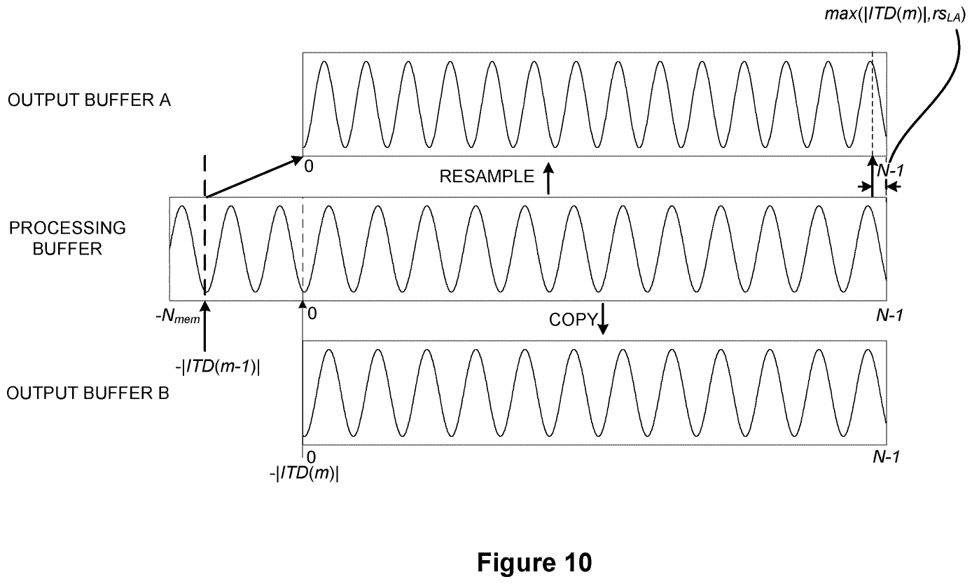

When the absolute value of the time delay of the current frame is larger than the absolute value of the previous frame, |ITD(m)|>|ITD(m−1)|, a transition is generated to allow a smooth transition between the delay values. This situation is illustrated in FIG. 9. The transition is done by extending the length of the frame from x_{buf}(n), n=ITD(m−1), . . . , N−1−ITD(m) of length t₁+|ITD(m−1)|−|ITD(m)| to an output frame of length t₁. If the transition time t₃ is larger than zero (i.e., t₃>0), the last t₃ samples of the output channel is simply copied from the processing buffer to arrive at a delay of |ITD(m)|, x_{buf}(n), n=N−1−t₃−|ITD(m)|, . . . N−1−|ITD(m)|. Here, one may also note that if |ITD(m−1)|=|ITD(m)|, the input length is the same as the output length and the resampling would be equivalent to a copy operation.

When the absolute value of the time delay decreases, i.e., |ITD(m)|<|ITD(m−1)|, the expression for the input frame length remains the same. However, the length t₁+|ITD(m−1)|-|ITD(m)| will now be larger than the resulting length t₁ and the resampling corresponds to shortening the length of the frame. This is illustrated in FIG. 10. In this example, ITD(m)=0 which means t₃=rs_{LA} and the last t₃ samples of the output buffer A are copied from the processing buffer 510.

### Case 2—Sign of ITD is Different and Non-Zero

If the sign of the ITD is changing, i.e., if ITD(m)·ITD(m−1)<0, a shift operation must be done on both channels. In this case the total transition length tₜₒₜ is split into two parts according to

$$\{ \begin{matrix}{t}_{1} = [ \frac{{t}_{tot} \vert I T D ( m - 1 ) \vert}{\vert I T D ( m - 1 ) \vert + \vert I T D ( m ) \vert} ] \\ {t}_{2} = {t}_{tot} - {t}_{1} \\ {n}_{1} = - \vert I T D ( m - 1 ) \vert \\ {L}_{in , 1} = {t}_{1} + \vert I T D ( m - 1 ) \vert \\ {n}_{2} = t \\ {L}_{in , 2} = {t}_{2} - \vert I T D ( m ) \vert \\ {n}_{3} = {t}_{tot} - \vert I T D ( m ) \vert\end{matrix}$$

where [⋅] denotes rounding to the nearest integer. Next, the output buffers A and B are assembled using the time-shifting the signal using the transition times t₁ and t₂ as illustrated in FIG. 11. First, a resampling is done of the buffer starting from n₁ of length L_{in,1} to the first t₁ samples of output buffer A. The last L_{sf}−t₁ samples are populated by copying the remainder of the processing buffer to output buffer A. Then, the first samples of the processing buffer starting from index 0 are copied to the first t₁ samples of output buffer B. The next t₂ samples of output buffer B are created by resampling the samples starting from n₂ in the processing buffer of length L_{in,2}. Finally, the last t₃ samples of the processing buffer are copied to output buffer B. The last L_{ITDmem} samples of the input frame are stored in memory for processing the next subframe. Output buffers A and B are assigned to the output channels 0 and 1 for left and right HRIR filtering respectively. The assignment of the output channels is done based on the signs of ITD(m) and ITD(m−1) as follows,

$$\{ \begin{matrix}( A , B ) \to ( 1 , 0 ) , ITD ( m - 1 ) = 0 ∧ ITD ( m ) > 0 ∨ ITD ( m - 1 ) > 0 \\ ( A , B ) \to ( 0 , 1 ) , otherwise\end{matrix}$$

where ∧ denotes logical AND and V denotes inclusive OR. The resampling operations are implemented using a polyphase filter with a sinc function from a lookup table. A benefit of dividing the transition length between the two channels is that the computational complexity of the resampler is proportional to the length of the transition, and by constraining the total transition length to tₜₒₜ the total complexity is kept below a certain limit. Further, the transition speed on left and right channels is kept roughly the same (roughly since integer rounding takes place). Since the artefacts from the transition is lower for lower transition speed, this keeps the transition artefacts at a minimum.

The resampling and copying operations may also be described referring to the indices of the buffers as follows. When the ITD signs are different, the first transition is to move from ITD(m−1) to 0 on output buffer A 550 and then shift from 0 to ITD(m) on output buffer B 560. An example of this process is illustrated in FIG. 11. In step 605, the resampler 570 fills the first t₁ samples of output buffer A 550. This is done by resampling the samples x_{buf}(n), n=−|ITD(m−1)|, . . . , t₁−1 of length t₁+|ITD(m−1)| to fit into the samples n=0, . . . , t₁−1 of output buffer A 550. In the same step, the samples x_{buf}(n), n=0, . . . , t₁−1 are copied to the corresponding indices n=0, . . . , t₁−1 in output buffer B 560. In step 607, the resampler 580 adapts the samples x_{buf}(n), n=t₁, . . . , t₁+t₂−1−|ITD(m)| of length t₂−|ITD(m)| to fit into the samples n=t₁, . . . , t₁+t₂−1 of the length t₂ in output buffer B 560. In case t₃>0, the last t₃ samples n=N−1−t₃−|ITD(m)|, . . . , N−1−|ITD(m)| are copied from the processing buffer 510 to output buffer B 560 in step 609. It should be noted that the output buffers 550 and 560 may have a different alignment such that the indices are shifted according to the processing buffer. In that case the above indices related to output buffers 550 and 560 would be shifted by that amount, but the segment still be appended in the same way as described here. For instance, output buffer A 550 in FIG. 7 and FIG. 9 may be offset by −|ITD(m)| to be aligned with the processing buffer indices. Further, the resampler 570 and resampler 580 may be realized using the same resampling function operating on different input.

In step 611, common for Case 1 and Case 2 above, the output buffer A 550 and the output buffer B 560 are assigned to output 0 and output 1. In the intermediate buffers A and B, A always corresponds to the channel that currently has a non-zero ITD and is delayed, while buffer B corresponds to the channel that has zero ITD. The intermediate buffers simplifies the processing using these assumptions, and the output assignment is a simple step which may be done at the end to assign the processed buffers to the correct output channel. The assignment of the output buffers depends on the signs of ITD(m−1) and ITD(m) following this pseudo-code:

```
● IF ITD(m − 1) = 0
  ○ IF ITD (m) > 0
    ▪ Output buffer A 550 → output 1, Output buffer B 560 → output 0
  ○ ELSE
    ▪ Output buffer A 550 → output 0, Output buffer B 560 → output 1
● ELSE
  ○ IF ITD(m − 1) > 0
    ▪ Output buffer A 550 → output 1, Output buffer B 560 → output 0
  ○ ELSE
    ▪ Output buffer 550 → output 0, Output buffer 560 → output 1
```

It may also be simplified into:

$$\{ \begin{matrix}( A , B ) \to ( 1 , 0 ) , ITD ( m - 1 ) = 0 ∧ ITD ( m ) > 0 ∨ ITD ( m - 1 ) > 0 \\ ( A , B ) \to ( 0 , 1 ) , otherwise\end{matrix}$$

where ∧ denotes logical AND and ∨ denotes inclusive OR, (A, B)→(1,0) means assigning Output buffer A 550 to output 1 and Output buffer B 560 to output 0 and (A, B)→(0,1) means assigning Output buffer A 550 to output 0 and Output buffer B 560 to output 1. The output buffers 0 and 1 may correspond to binaural channels left and right respectively. The numbering may also be done differently, e.g. output buffers 1 and 2.

In other words, if ITD(m−1) is zero, the current ITD, ITD(m), is used to determine which buffer to delay. If ITD(m) is positive, output 0 is ahead of output 1 and output 1 should be delayed. If ITD(m) is negative, output 1 is ahead of output 0 and output 0 should be delayed. If ITD(m−1) is not zero, the previous ITD, ITD(m−1), decides which buffer to shift first. If ITD(m−1) is positive, output 1 is shifted first in buffer A 550, followed by a shift of output 0 in buffer B 560. If ITD(m−1) is negative, output 0 is shifted first in buffer A 550, followed by a shift of output 1 in buffer B 560. It should be noted that the definition of sign of ITD(m) may be reversed, in which case output 0 and output 1 would switch places above.

It should be noted that step 611 may happen before step 605 by assigning the output buffer A 550 and output buffer B 560 already to the designated outputs 1 and 2, such that the output is populated during steps 605-611. In an embodiment, output 0 and output 1 may correspond to left and right channel respectively.

Resampling with Sinc Function

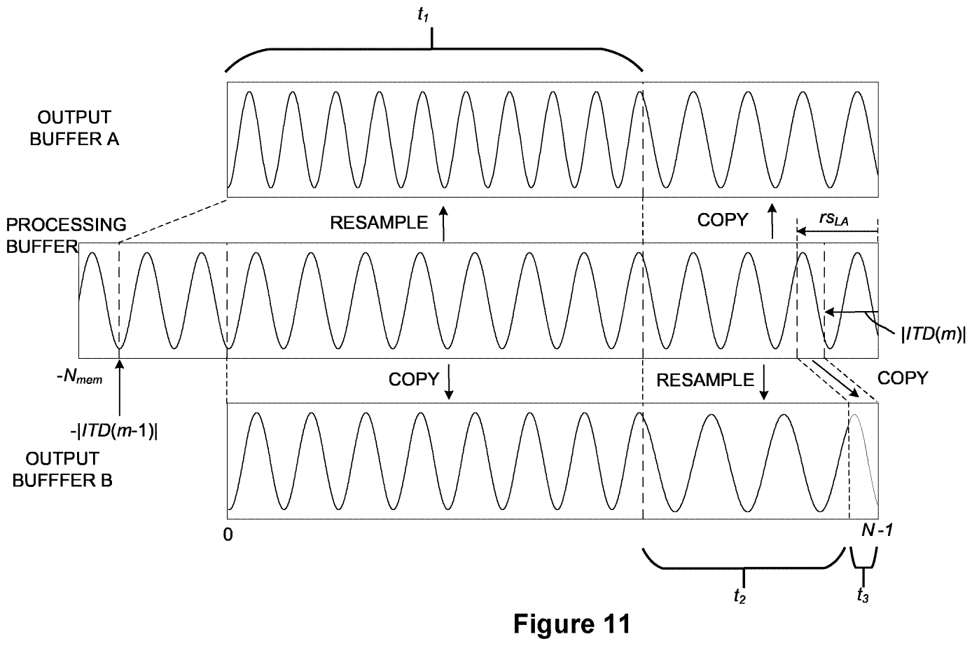

The described method relies on a resampling function to handle compressing and extending segments of the signal. This may be realized using a sinc resampling function, as illustrated in FIG. 12. Given an input signal y(n) of length Lᵢₙ and an output length Lₒᵤₜ, the input signal may be resampled at the fractional indices

$${n}_{frac} = \frac{{L}_{in}}{{L}_{out}} k ,$$

k=0, 1, 2, . . . , Lₒᵤₜ−1 following these steps. For each n, calculate

$$Δ n = {n}_{frac} - ⌊ {n}_{frac} ⌋$$

where └⋅┘ represents a round-down operation.

Since the sinc function is computationally complex to compute, it may be desirable to store it in a table with a predefined resolution. For instance, a resolution of R_{sinc}=64, meaning there are 64 samples between the zero crossings of the sinc functions may be suitable (see FIG. 12). The corresponding index in the sinc table could then be found at

$$Δ {n}_{64} = ⌊ Δ {nR}_{sinc} + 0.5 ⌋$$

The output values z(k) may be found by the sum

$${\sum }_{j = - 4}^{5} y ( ⌊ {n}_{frac} ⌋ + j ) SincTable ( - Δ {n}_{64} + {jR}_{sinc} )$$

$$where$$

$${n}_{frac} = \frac{{L}_{in}}{{L}_{out}} k$$

$$Δ n = {n}_{frac} - ⌊ {n}_{frac} ⌋$$

$$Δ {n}_{64} = ⌊ Δ {nR}_{sinc} + 0.5 ⌋$$

Note that while the above embodiments were described using an audio object renderer (e.g., a decoder), the various embodiments described above could also be done at an encoder where the shifted outputs (i.e., output 0 and output 1) are shifted at the encoder instead of at the audio object renderer.

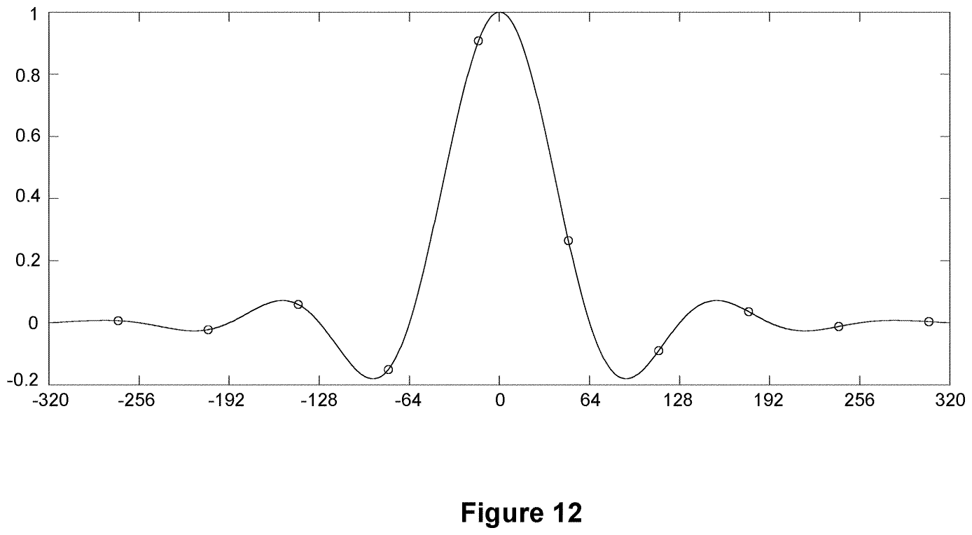

FIG. 13 shows an audio object renderer 114 (e.g., a decoder) in accordance with some embodiments where the audio object renderer 114 is implemented as a stand-alone device. As used herein, an audio object renderer refers to a device capable, configured, arranged and/or operable to decode encoded objects and communicate with network nodes, encoders, and/or decoders. Examples of an audio object renderer include, but are not limited to, a smart phone, mobile phone, cell phone, voice over IP (VoIP) phone, wireless local loop phone, desktop computer, personal digital assistant (PDA), wireless cameras, gaming console or device, storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

An audio object renderer may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a decoder may not necessarily have a user in the sense of a human user who owns and/or operates the relevant device.

The audio object renderer 114 includes processing circuitry 1302 that is operatively coupled via a bus 1304 to an input/output interface 1306, a power source 1308, a memory 1310, a communication interface 1312, and/or any other component, or any combination thereof. Certain decoders may utilize all or a subset of the components shown in FIG. 13. The level of integration between the components may vary from one decoder to another decoder. Further, certain decoders may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, an actuator, an emitter, a smartcard, another output device, or any combination thereof. An input device may allow a user to capture information into the audio object renderer 114. Examples of an input device include a touch-sensitive or presence-sensitive display, a camera (e.g., a digital camera, a digital video camera, a web camera, etc.), a microphone, a sensor, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the audio object renderer 114 via input circuitry or an interface such as an electrical power cable. Delivering power may be, for example, for charging of the power source 1308. Power circuitry may perform any formatting, converting, or other modification to the power from the power source 1308 to make the power suitable for the respective components of the audio object renderer 114 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the audio object renderer 114, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the audio object renderer 114 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, an audio object renderer may provide an output of decoded data, through its communication interface 1312, via a wireless connection to a network node.

An audio object renderer, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a thermostat, an electrical door lock, a connected doorbell, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement. A decoder in the form of an IoT device comprises circuitry and/or software in dependence of the intended application of the IoT device in addition to other components as described in relation to the audio object renderer 114 shown in FIG. 13.

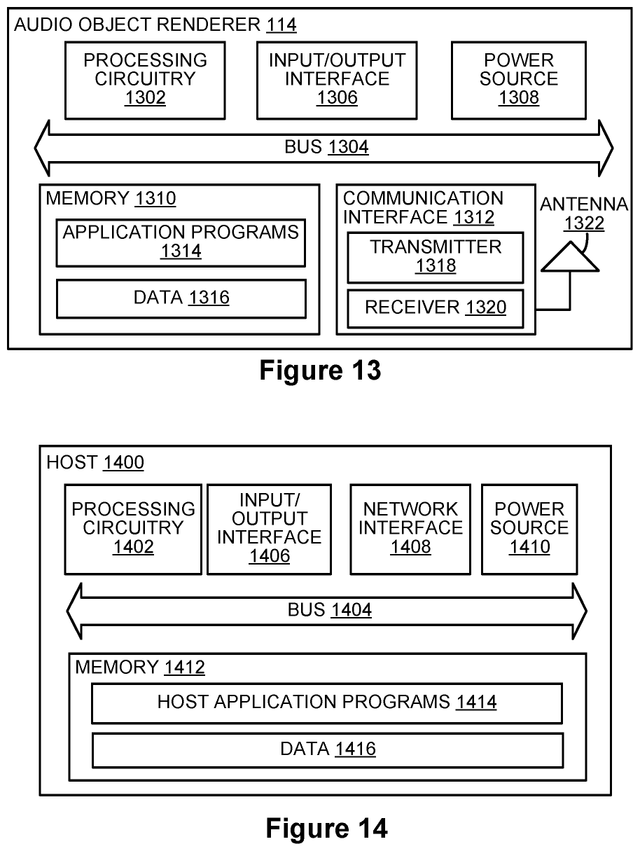

FIG. 14 is a block diagram of a host 1400 in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIG. 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., EVS, IVAS, FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

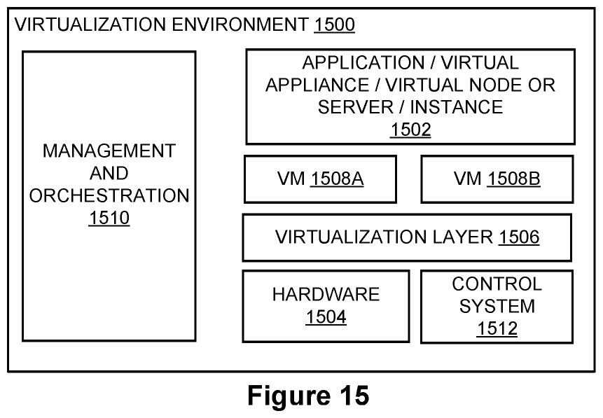

FIG. 15 is a block diagram illustrating a virtualization environment 1500 in which functions implemented by some embodiments of the audio object renderer 114 or components of the audio object renderer 114 may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a decoder, encoder, network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508A and 1508B (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

Although the computing devices described herein (e.g., decoders, audio object renderers, encoders, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### EXAMPLE EMBODIMENTS

1. A method in an inter-channel time difference, ITD, synthesizer (220, 340, 1502) comprising:
receiving (401) a current ITD and audio frames, wherein each frame m comprises N samples;
storing (403) at least a part of the current input audio frame in signal memory;
determining (405) transition times t₁, t₂ to perform a time shift to apply to at least one of an output signal 0 and an output signal 1 based on an inter-channel time difference, ITD, of the current input audio frame and an ITD of a previous input audio frame; and
applying (407) the time shift within the transition times t₁, t₂ determined in generation of the output signal 0 and the output signal 1.
   2. The method of Embodiment 1, wherein the audio frames are part of an object audio signal with position metadata describing a position relative to a listener, the method further comprising obtaining the time shift from the position metadata.
   3. The method of any of Embodiments 1-2, further comprising:
computing (801) a total transition length based on a frame length of the frame m and a lookahead memory rs_{LA} required for resampling, the total transition divided into two parts comprising t₁ and t₂
determining (803) a buffer length t₃ based the lookahead memory rs_{LA}; and
determining (805) a total transition length based on a maximum allowed transition length and the buffer length t₃
   4. The method of Embodiment 3, wherein determining the buffer length t₃ comprises determining the buffer length t₃ according to:

$${t}_{3} = max ( 0 , {rs}_{LA} - \vert ITD ( m - 1 ) \vert )$$

and determining the total transition length according to:

$${t}_{tot} = {N}_{max} - {t}_{3}$$

wherein Nₘₐₓ≤N
5. The method of any of Embodiments 1-4, wherein determining the transition times t₁, t₂ comprises:
responsive to the sign of the current ITD and the previous ITD are the same, assigning the total transition length to one of the transition times t₁, t₂ and setting the other one to zero.
   6. The method of any of Embodiments 1-4, wherein determining the transition times t₁, t₂ comprises:
responsive to the sign of the current ITD and a sign of the previous ITD being different, applying a shift operation on both output signal 0 and output signal 1 by splitting the total transition length into two parts to determine the transition times t₁, t₂.
   7. The method of Embodiment 6, wherein splitting the total transition length into two parts to determine the transition times t₁, t₂ comprises splitting the total transition length according to:

$$\{ \begin{matrix}{t}_{1} = [ \frac{{t}_{tot} \vert ITD ( m - 1 ) \vert}{\vert ITD ( m ) \vert + \vert ITD ( m - 1 ) \vert} ] \\ {t}_{2} = {t}_{tot} - {t}_{1}\end{matrix}$$

where [⋅] represents a rounding operation to the nearest integer.
8. The method of any of Embodiments 3-7, further comprising:
populating a processing buffer (510) using a current input audio frame of the object audio and signal memory;
wherein applying the transition times t₁, t₂ determined in generation of the output signal 0 and output signal 1 comprises:
   responsive to the sign of the current ITD and the sign of the previous ITD are the same or responsive to one of the current ITD and the previous ITD is zero:
      adjusting the processing buffer (510) to populate a first output buffer (550) by assigning the total transition length to t₁ and setting t₂ to zero; and
      copying an input signal part of the processing buffer (510) to a second output buffer (560).
         9. The method of Embodiment 8, wherein applying the transition times t₁, t₂ determined in generation of the output signal 0 and output signal 1 further comprises:
responsive to ITD(m)=ITD(m−1) and a sign of one of the current ITD and the previous ITD is negative, thereby indicating that one of the output signal 0 and output signal 1 is ahead of the other of the output signal 0 and the output signal 1, delaying an output buffer comprising whichever one of the first output buffer (550) or the second output buffer (560) is associated with the other of the output signal 0 and output signal 1 by the total transition length.
   10. The method of any of Embodiments 8-9, wherein applying the transition times t₁, t₂ determined in generation of the output signal 0 and output signal 1 further comprises:
responsive to |ITD(m)|>|ITD(m−1)|, generating a transition by:
   extending the length of the frame in the processing buffer (510) from x_{buf}(n), n=|ITD(m−1)|, . . . , N−1−|ITD(m)| of length t₁+|ITD(m−1)|−|ITD(m)| to an output frame of length t₁; and
   responsive to the buffer length t₃ is larger than zero, adding the last t₃ samples of the output channel by copying from the processing buffer (510),

$${x}_{buf} ( n ) , n = N - 1 - t 3 - \vert ITD ( m ) \vert , … N - 1 - \vert ITD ( m ) \vert .$$

11. The method of any of Embodiments 8-10, wherein applying the transition times t₁, t₂ determined in generation of the output signal 0 and output signal 1 further comprises:
responsive to |ITD(m)|<|ITD(m−1)|, adding the last t_3 samples of the first output buffer (550) by copying from the processing buffer (510).
   12. The method of any of Embodiments 8-11, wherein applying the transition times t₁, t₂ determined in generation of the output signal 0 and output signal 1 further comprises:
responsive to ITD(m)·ITD(m−1)<0, splitting the total transition length according to

$$\{ \begin{matrix}{t}_{1} = [ \frac{{t}_{tot} \vert ITD ( m - 1 ) \vert}{\vert ITD ( m ) \vert + \vert ITD ( m - 1 ) \vert} ] \\ {t}_{2} = {t}_{tot} - {t}_{1}\end{matrix}$$

where [⋅] represents a rounding operation to a nearest integer, where splitting the total transition length comprises:
   resampling samples x_{buf}(n), n=−|ITD(m−1)|, . . . , t₁−1 of length t₁+|ITD(m−1)| to fit into samples n=0, . . . , t₁-1 of the first output buffer (550);
   copying samples x_{buf}(n), n=0, . . . , t₁−1 to corresponding indices in the second output buffer (560);
   adapting samples x_{buf}(n), n=t₁, . . . , t₁+t₂−1−|ITD(m)| of length t₂−|ITD(m)| to fit into the samples n=t₁, . . . , t₁+t₂−1 of the length t₂ in the second output buffer (560).
      13. The method of any of Embodiments 8-12, wherein applying the transition times t₁, t₂ determined in generation of the output signal 0 and output signal 1 further comprises:
responsive to ITD(m−1)=0 and ITD(m)>0, assigning the first output buffer (550) to output signal 1 and the second output buffer (560) to output signal 0;
responsive to ITD(m−1)=0 and ITD(m)≤0, assigning the first output buffer (550) to output signal 0 and the second output buffer (560) to output signal 1;
responsive to ITD(m−1)>0, assigning the first output buffer (550) to output signal 1 and the second output buffer (560) to output signal 0; and
responsive to ITD(m−1)<0, assigning the first output buffer (550) to output signal 0 and the second output buffer (560) to output signal 1.
   14. An apparatus (114, 1502) having an ITD synthesizer adapted to:
receiving (401) a current ITD and audio frames, wherein each frame m comprises N samples;
storing (403) at least a part of the current input audio frame in signal memory;
determining (405) transition times t₁, t₂ to perform a time shift to apply to at least one of an output signal 0 and an output signal 1 based on an inter-channel time difference, ITD, of the current input audio frame and an ITD of a previous input audio frame; and
applying (407) the time shift within the transition times t₁, t₂ determined in generation of the output signal 0 and the output signal 1.
   15. The apparatus (114, 300, 1502) of Embodiment 14, wherein the ITD synthesizer (220, 340, 1502) is further adapted to perform according to any of Embodiments 2-12.
   16. An apparatus (114, 300, 1502) having an inter-channel time difference, ITD, synthesizer (220, 340, 1502) comprising:
processing circuitry (1202); and
memory (1210) coupled with the processing circuitry, wherein the memory includes instructions that when executed by the processing circuitry causes the ITD synthesizer (220, 340, 1502) to perform operations comprising:
receiving (401) a current ITD and audio frames, wherein each frame m comprises N samples;
storing (403) at least a part of the current input audio frame in signal memory;
determining (405) transition times t₁, t₂ to perform a time shift to apply to at least one of an output signal 0 and an output signal 1 based on an inter-channel time difference, ITD, of the current input audio frame and an ITD of a previous input audio frame; and
applying (407) the time shift within the transition times t₁, t₂ determined in generation of the output signal 0 and the output signal 1.
   17. The apparatus (114, 300, 1502) of Embodiment 16 wherein the memory includes further instructions that when executed by the processing circuitry causes the ITD synthesizer (220, 340, 1502) perform according to any of Embodiments 2-13.
   18. A computer program comprising program code to be executed by processing circuitry (1202) of an apparatus (112, 300, 1502) having an inter-channel time difference, ITD, synthesizer (220, 340, 1502) whereby execution of the program code causes the ITD synthesizer (220, 340, 1502) to perform operations comprising:
receiving (401) a current ITD and audio frames, wherein each frame m comprises N samples;
storing (403) at least a part of the current input audio frame in signal memory;
determining (405) transition times t₁, t₂ to perform a time shift to apply to at least one of an output signal 0 and an output signal 1 based on an inter-channel time difference, ITD, of the current input audio frame and an ITD of a previous input audio frame; and
applying (407) the time shift within the transition times t₁, t₂ determined in generation of the output signal 0 and the output signal 1.
   19. The computer program of Embodiment 18 comprising further program code, whereby execution of the program code causes the ITD synthesizer (220, 340, 1502) to perform according to any of Embodiments 2-13.
   20. A computer program product comprising a non-transitory storage medium including program code to be executed by processing circuitry (1202) of an apparatus (114, 300, 1502) having an inter-channel time difference, ITD, synthesizer (220, 340, 1502) whereby execution of the program code causes the ITD synthesizer (220, 340, 1502) to perform operations comprising:
receiving (401) a current ITD and audio frames, wherein each frame m comprises N samples;
storing (403) at least a part of the current input audio frame in signal memory;
determining (405) transition times t₁, t₂ to perform a time shift to apply to at least one of an output signal 0 and an output signal 1 based on an inter-channel time difference, ITD, of the current input audio frame and an ITD of a previous input audio frame; and
applying (407) the time shift within the transition times t₁, t₂ determined in generation of the output signal 0 and the output signal 1.
   21. The computer program of Embodiment 19, wherein the non-transitory storage medium includes further program code, whereby execution of the program code causes the ITD synthesizer (220, 340, 1502) to perform according to any of Embodiments 2-13.

1. A method for adjusting timing of output audio signals to achieve desired inter-channel time difference, ITD, between output audio signals, the method comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal.

2. The method of claim 1, wherein at least a part of the audio frame is stored in memory to be used in synthesizing ITD in the following frame.

3. The method of claim 1, wherein the audio frames are part of an audio object comprising an audio signal and position metadata describing an object position, the method further comprising obtaining the time shift from the position metadata.

4. The method of claim 1, further comprising:
computing a total transition length based on a frame length of the current frame m and a lookahead memory rs_{LA} required for resampling, the total transition length being divided into two parts comprising t₁ and t₂;
determining a transition length t₃ based the lookahead memory rs_{LA}; and
determining the total transition length based on a maximum allowed transition length and the transition length t₃.

5. The method of claim 4, wherein determining the transition length t₃ comprises determining the transition length t₃ according to:
t₃=max(0,rs_{LA}−|ITD(m−1)|), where ITD(m−1) is the ITD of the previous audio frame comprising N samples, and determining the total transition length according to:
$${t}_{tot} = {N}_{max} - {t}_{3} , wherein {N}_{max} \leq N ,$$
wherein Nₘₐₓ is the maximum allowed transition length.

6. The method of claim 1, wherein determining the transition times t₁, t₂ comprises:
responsive to the sign of the current ITD and the previous ITD being the same, assigning the total transition length to one of the transition times t₁, t₂ and setting the other one to zero.

7. The method of claim 1, wherein determining the transition times t₁, t₂ comprises:
responsive to the sign of the current ITD and a sign of the previous ITD being different, applying a shift operation on both the first output signal and the second output signal by splitting the total transition length into two parts to determine the transition times t₁, t₂.

8. The method of claim 7, wherein splitting the total transition length into two parts to determine the transition times t₁, t₂ comprises splitting the total transition length according to:
$$\begin{matrix}{t}_{1} = [ \frac{{t}_{tot} \vert ITD ( m - 1 ) \vert}{\vert ITD ( m ) \vert + \vert ITD ( m - 1 ) \vert} ] \\ {t}_{2} = {t}_{tot} - {t}_{1}\end{matrix}$$
where ITD(m) is the current ITD and [⋅] represents a rounding operation to the nearest integer.

9. The method of claim 4, further comprising:
populating a processing buffer using the audio frame;
wherein applying the transition times t₁, t₂ determined in generation of the first output signal and the second output signal comprises:
responsive to the sign of the current ITD and the sign of the previous ITD being the same or responsive to one of the current ITD and the previous ITD being zero:
adjusting the processing buffer to populate a first output buffer by assigning the total transition length to t₁ and setting t₂ to zero; and
copying an input signal part of the processing buffer to a second output buffer.

10. The method of claim 9, wherein applying the determined transition times t₁, t₂ in generation of the first output signal and the second output signal further comprises:
responsive to ITD(m)=ITD(m−1) and a sign of one of the current ITD and the previous ITD being negative, thereby indicating that one of the first output signal and the second output signal is ahead of the other of the first output signal and the second output signal, delaying an output buffer comprising whichever one of the first output buffer or the second output buffer is associated with the other of the first output signal and the second output signal by the total transition length.

11. The method of claim 9, wherein applying the determined transition times t₁, t₂ in generation of the first output signal and the second output signal further comprises:
responsive to |ITD(m)|>|ITD(m−1)|, generating a transition by:
extending the length of the frame in the processing buffer from x_{buf}(n), n=|ITD(m−1)|, . . . , N−1−|ITD(m)| of length t₁+|ITD(m−1)|−|ITD(m)| to an output frame of length t₁; and
responsive to the transition length t₃ being larger than zero, adding the last t₃ samples of the output channel by copying from the processing buffer,
$${x}_{buf} ( n ) , n = N - 1 - t 3 - \vert ITD ( m ) \vert , … N - 1 - \vert ITD ( m ) \vert .$$

12. The method of claim 9, wherein applying the determined transition times t₁, t₂ in generation of the first output signal and the second output signal further comprises:
responsive to |ITD(m)|<|ITD(m−1)|, adding the last t₃ samples of the first output buffer by copying from the processing buffer.

13. The method of claim 9, wherein applying the determined transition times t₁, t₂ in generation of the first output signal and the second output signal further comprises:
responsive to ITD(m)·ITD(m−1)<0, splitting the total transition length according to
$$\{ \begin{matrix}{t}_{1} = [ \frac{{t}_{tot} \vert ITD ( m - 1 ) \vert}{\vert ITD ( m ) \vert + \vert ITD ( m - 1 ) \vert} ] \\ {t}_{2} = {t}_{tot} - {t}_{1}\end{matrix}$$
where [⋅] represents a rounding operation to a nearest integer, where splitting the total transition length comprises:
resampling samples x_{buf}(n), n=−|ITD(m−1)|, . . . , t₁−1 of length t₁+|ITD(m−1)| to fit into samples n=0, . . . , t₁−1 of the first output buffer;
copying samples x_{buf}(n), n=0, . . . , t₁−1 to corresponding indices in the second output buffer;
resampling samples x_{buf}(n), n=t₁, . . . , t₁+t₂−1−|ITD(m)| of length t₂−|ITD(m)| to fit into the samples n=t₁, . . . , t₁+t₂−1 of the length t₂ in the second output buffer.

14. The method of claim 9, wherein generation of the second output signal further comprises:
responsive to the transition length t₃ being larger than zero, adding the last t₃ samples of the output channel by copying from the processing buffer (510), x_{buf}(n), n=N−1−t₃−|ITD(m)|, . . . N−1−|ITD(m)|.

15. The method of claim 9, wherein applying the determined transition times t₁, t₂ in generation of the first output signal and the second output signal further comprises:
responsive to ITD(m−1)=0 and ITD(m)>0, assigning the first output buffer to the second output signal and the second output buffer (560) to the first output signal;
responsive to ITD(m−1)=0 and ITD(m)≤0, assigning the first output buffer to the first output signal and the second output buffer (560) to the second output signal;
responsive to ITD(m−1)>0, assigning the first output buffer to the second output signal and the second output buffer to the first output signal; and
responsive to ITD(m−1)<0, assigning the first output buffer to the first output signal and the second output buffer (560) to the second output signal.

16. An apparatus for adjusting timing of output audio signals to achieve desired inter-channel time difference, ITD, between output audio signals, the apparatus being adapted to:
receive a current ITD value and an audio frame;
determine transition times t₁, t₂ to perform a time shift to apply to at least one of a first output signal and a second output signal based on the ITD of a current frame and an ITD of a previous frame; and
apply the time shift within the determined transition times t₁, t₂ in generation of the first output signal and the second output signal.

17. The apparatus of claim 16, wherein the apparatus is further adapted to perform the method for adjusting timing of output audio signals to achieve desired inter-channel time difference, ITD, between output audio signals, the method comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal,
wherein at least a part of the audio frame is stored in memory to be used in synthesizing ITD in the following frame.

18. An apparatus comprising:
processing circuitry; and
memory coupled with the processing circuitry, wherein the memory includes instructions that when executed by the processing circuitry causes the apparatus to perform operations comprising:
receiving a current inter-channel time difference, ITD, value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal.

19. The apparatus of claim 18 wherein the memory includes further instructions that when executed by the processing circuitry causes the apparatus to perform operations for adjusting timing of output audio signals to achieve desired inter-channel time difference, ITD, between output audio signals, the method comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal,
wherein at least a part of the audio frame is stored in memory to be used in synthesizing ITD in the following frame.

20. A computer program comprising program code to be executed by processing circuitry of an apparatus whereby execution of the program code causes the apparatus to perform operations comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal.

21. The computer program of claim 20 comprising further program code, whereby execution of the program code causes the apparatus to adjust timing of output audio signals to achieve desired inter-channel time difference, ITD, between output audio signals, the method comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal,
wherein at least a part of the audio frame is stored in memory to be used in synthesizing ITD in the following frame.

22. A computer program product comprising a non-transitory storage medium including program code to be executed by processing circuitry of an apparatus whereby execution of the program code causes the apparatus to perform operations comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal.

23. The computer program product of claim 22, wherein the non-transitory storage medium includes further program code, whereby execution of the program code causes the apparatus to adjust timing of output audio signals to achieve desired inter-channel time difference, ITD, between output audio signals, the method comprising:
receiving a current ITD value and an audio frame;
determining transition times t₁, t₂ to perform a time shift to apply to at least one of a first output signal and a second output signal based on the ITD of a current frame and an ITD of a previous frame; and
applying the time shift within the determined transition times t₁, t₂ in generation of the first output signal and the second output signal,
wherein at least a part of the audio frame is stored in memory to be used in synthesizing ITD in the following frame.

24. The apparatus of claim 18, wherein the audio frames are part of an audio object comprising an audio signal and position metadata describing an object position, the method further comprising obtaining the time shift from the position metadata.

25. The apparatus of claim 18, wherein computing a total transition length based on a frame length of the current frame m and a lookahead memory rs_{LA} required for resampling, the total transition length being divided into two parts comprising t₁ and t₂; wherein determining a transition length t₃ based the lookahead memory rs_{LA}, and wherein determining the total transition length based on a maximum allowed transition length and the transition length t₃.

26. The apparatus of claim 18, wherein determining the transition times t₁, t₂ comprises responsive to the sign of the current ITD and the previous ITD being the same, assigning the total transition length to one of the transition times t₁, t₂ and setting the other one to zero.
